(19) United States
(12) Patent Application Publication
(10) Pub. No.: US 2017/0140796 A1
(43) Pub. Date: May 18, 2017

(54) INTELLIGENT SEGMENT MARKING IN RECORDINGS

(71) Applicant: International Business Machines Corporation, Armonk, NY (US)

(72) Inventors: Nathan Fontenot, Georgetown, TX (US); Fionnuala G. Gunter, Austin, TX (US); Christy L. Norman Perez, Austin, TX (US); Michael T. Strosaker, Austin, TX (US); George C. Wilson, Austin, TX (US)

(73) Assignee: International Business Machines Corporation, Armonk, NY (US)

(21) Appl. No.: 15/052,127

(22) Filed: Feb. 24, 2016

Related U.S. Application Data
(63) Continuation of application No. 14/944,556, filed on Nov. 18, 2015.

(51) Int. Cl. G11B 27/34; G06F 17/24; G11B 27/11; G06F 17/30

(52) U.S. Cl. CPC G11B 27/34; G06F 17/30516; G06F 17/241; G11B 27/11

(57) ABSTRACT

A stream of data contributions during a period is collected from a social media data source, the period spanning a broadcast of a content. The stream is analyzed to identify a change in a level of the data contributions during a sub-period of the period. A first time is selected to mark a beginning of the sub-period. A second time is selected to mark an ending of the sub-period. A data fragment is extracted from the data contributions occurring during the sub-period in the stream, the data fragment being descriptive of the content during the sub-period. In a recording of the content, a portion of the recording between the starting time and the ending time is selected as a segment of interest. The recording is annotated with the starting time, the ending time, and the data fragment to identify the segment of interest.

### TECHNICAL FIELD

The present invention relates generally to a method for annotating recorded content. More particularly, the present invention relates to a method for intelligent segment marking in recordings.

### BACKGROUND

Audio and video content is collectively and interchangeably referred to hereinafter as “content”. Content can be recorded or presented as a live broadcast of a real-time event. Recorded content can be played back at any time after the real-time event from which the recording is made.

Recorded content is available in many formats, including but not limited to Digital Video Disc (DVD) and online streaming. Many recordings provide skip-points within the recording. A skip-point allows a user to skip to a point within the recording to begin playback from that point. The chapter selection feature on DVDs is one example of presenting preselected skip-points within the recorded content of the DVD.

A segment of interest in a recording is a portion of the recorded content that begins within the recording at a starting time on a playback timeline of the recording, and ends within the recording at an ending time on the playback timeline of the recording. A chapter of a recorded movie on DVD is an example of a segment of interest. For example, the playback timeline of the movie may begin at time 0:00:00 (zero hours, zero minutes, and zero seconds) and ends at time 2:11:16 (two hours, eleven minutes, and sixteen seconds). Between 0:00:00 and 2:11:16, a chapter of the movie begins at time 0:32:40 and ends at time 0:58:02.

Social media comprises any network, channel, or technology for facilitating communication between a large number of individuals and/or entities collectively referred to as “users”. Some common examples of social media are Facebook or Twitter, each of which facilitates communications in a variety of forms between large numbers of users (Facebook is a trademark of Facebook, Inc. in the United States and in other countries. Twitter is a trademark of Twitter Inc. in the United States and in other countries.) Social media, such as Facebook or Twitter allow users to interact with one another individually, in a group, according to common interests, casually or in response to an event or occurrence, and generally for any reason or no reason at all.

Some other examples of social media are websites or data sources associated with radio stations, news channels, magazines, publications, blogs, and sources or disseminators of news or information. Some more examples of social media are websites or repositories associated with specific industries, interest groups, action groups, committees, organizations, teams, or other associations of users.

A user's contributions or interactions with the social media can include any type or size of data. For example, a user can post text, pictures, videos, links, or combinations of these and other forms of information to a social media website. Furthermore, such information can be posted in any order, at any time, for any reason, and with or without any context.

### SUMMARY

An embodiment collects, from a social media data source, a stream of data contributions during a period, the period spanning a broadcast of a content. The embodiment analyzes, using a processor and a memory, the stream to identify a change in a level of the data contributions during a sub-period of the period. The embodiment selects a first time to mark a beginning of the sub-period. The embodiment selects a second time to mark an ending of the sub-period. The embodiment extracts from the data contributions occurring during the sub-period in the stream, a data fragment, the data fragment being descriptive of the content during the sub-period. The embodiment selects, in a recording of the content, a portion of the recording between the starting time and the ending time as a segment of interest. The embodiment annotates the recording with the starting time, the ending time, and the data fragment to identify the segment of interest.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for intelligent segment marking in recordings in accordance with an illustrative embodiment;

FIG. 4 depicts a manner of identifying a segment of interest in a given content in accordance with an illustrative embodiment; and

FIG. 5 depicts a flowchart of an example process for intelligent segment marking in recordings in accordance with an illustrative embodiment.

### DETAILED DESCRIPTION

Presently, skip-points are predetermined by the manufacturer of the recording based on the manufacturer's knowledge of the recorded content. For example, in a recorded movie on a DVD, the chapter selection and scene selection skip-points are all selected according to the manufacturer's knowledge of the movie content.

The illustrative embodiments recognize that such manner of creating skip-points only creates segments of interest according to the manufacturer of the recording. The illustrative embodiments recognize that users who hears or views the content often like or dislike certain portions of the content as well. Such portions are also user-selected segments of interest, which cannot be presently identified in the recording of the content.

For example, suppose that a live debate is being broadcast by a television station. Many viewers watch the debate (content) live, and produce opinions about which portions of the debate they found particularly interesting. Similarly, a football game may be broadcast live, and viewers might particularly like certain plays, such as touchdowns or penalties, during the game (content).

Recordings of previously broadcasted live content are often made available to users for later viewing. For example, digital video recorders are ubiquitously available for recording live television broadcast for later viewing. The illustrative embodiments recognize that presently segments of interest cannot be identified in such recordings based on the responses of the users to the content.

The illustrative embodiments used to describe the invention generally address and solve the above-described problems and other problems related to identifying segments of interest in recorded content.

An embodiment can be implemented as a software application. The application implementing an embodiment can be configured as a modification of an existing recording application or device, as a separate application that operates in conjunction with an existing recording application or device, a standalone application, or some combination thereof.

Broadcast content either includes metadata, or metadata can be extracted from the content. For example, a broadcast content, such as a sporting event or a debate, has a title and a time of the broadcast. A broadcast content, such as a movie or a television show, may include the names of the cast, the producer, the director, and the studio, or such information can be extracted from the movie or show's content. The title, the time of the broadcast, and the names of the cast, the producer, the director, and the studio are some non-limiting examples of metadata associated with content and contemplated by the illustrative embodiments. A set of metadata can be associated with content, and a subset of the set of metadata is usable to uniquely identify the content.

An embodiment detects a live broadcast of a particular content. Using a subset of the metadata associated with the content, the embodiment searches one or more social media sources for data that references the subset of the metadata and is added to the one or more social media at the time of the broadcast. For example, for a live broadcast of a sporting event content, the embodiment selects a name metadata of a team that is participating in the event. The embodiment searches, as a non-limiting example, Twitter data to extract a stream of data that is being contributed to the hashtag of the team's name while the team is playing in the event.

In this example, Twitter may receive data contributions to more than one hashtags, e.g., the hashtag of the team name, the hashtag of the sporting event name, the hashtag of the television network that is providing the live broadcast, and the like. Similarly, Facebook may receive data contributions to a page of the team, a page of the television network, a handle of a player on the team, and the like. The ongoing contribution and availability of data relative to a metadata, e.g., relative to a hashtag or other suitable mechanism in social media, is referred to herein as a data stream.

Thus, the embodiment collects such data from one or more streams of data being added or contributed to one or more social media sources. The embodiment collects the data up to the end of the broadcast.

The embodiment analyzes the data at the end of the broadcast to determine a normal or baseline level of data contribution relative to the content during the broadcast. For example, in case of content that has low viewership or is relatively uncontroversial, the baseline amount of data contributed to a data stream may be less than the amount of data contributed to a high viewership or controversy evoking content.

A level of data contribution is indicative of a volume or amount of data contribution, a frequency of data contribution, or both. A baseline level is a level that is observed consistently throughout the duration of the broadcast of the content without a significant increase or decrease in the amount or frequency of the data being contributed to a stream. For example, it may be normal to have one hundred data contributions per minute, e.g., Tweets per minute, to a college football team's hashtag when their game is being broadcast, and it may be normal to have ten thousand data contributions per minute to a national football team's hashtag when their championship game is being broadcast.

A baseline level may be a baseline band. For example, it may be normal to have between one hundred and two hundred data contributions per minute to a college football team's hashtag when their game is being broadcast.

The embodiment further determines whether the data contributions during the broadcast exhibit any significant deviation from the baseline level. For example, the embodiment determines whether for any duration within the duration of the broadcast, the level of data contribution exceeds the baseline by at least a threshold amount or frequency. A duration where the data contributions deviate significantly from the baseline is selected by the embodiment as a duration spanning a segment of interest.

Conversely, if for any duration within the duration of the broadcast, the level of data contribution falls below the baseline by at least a threshold amount or frequency, such a duration is selected by the embodiment as a duration spanning a segment of interest. In this case, the segment is of interest because the users appear to have less than a normal level of interest in the segment, such as when the game is suspended for a duration due to weather.

The embodiment further determines a data fragment that is common to a threshold amount of the data contributed during the segment of interest. For example, if the segment pertains to a touchdown, a majority of the data contributed during the touchdown segment of interest is likely to include the word “touchdown”—an example data fragment—in the contributed data. Similarly, if the segment pertains to pause in the game due to weather, a majority of the data contributed during the pause segment of interest is likely to include the word “rain” or “bad weather” or something similar—another example data fragment—in the contributed data.

In many cases, data contributions deviate from the baseline by more than a threshold value sometime after an event that makes a segment interesting or uninteresting has occurred in the content. Accordingly, the embodiment determines a starting time of a duration of a segment of interest by identifying a time at which the data contribution level deviated by more than a threshold value, and adding a predetermined amount of lead time.

The embodiment determines an ending time of the duration of the segment of interest by identifying a time at which the deviation of the data contribution level returns within the threshold value of the baseline. Optionally, the embodiment can be configured to add a trailing amount of time after the deviation returns within the threshold value of the baseline.

Operating in this manner, the embodiment determines any number of segments of interest that might be present within the duration of the broadcast content. The embodiment extends the metadata of the content in the recording. Specifically, the extended metadata includes the starting time and ending time of each segment of interest in the recording. Optionally, the embodiment also stores in the extended metadata, the extracted data fragment for some or all segments of interest.

A method of an embodiment described herein, when implemented to execute on a device or data processing system, comprises substantial advancement of the functionality of that device or data processing system in intelligent segment marking in recordings. For example, presently available recorded content identifies only predetermined skip-points but not segments of interests according to the users of the content based on the broadcast of the content. An embodiment crowd-sources data from social media data streams to identify one or more segments of interest in a broadcast content. The embodiment modifies the metadata of the content in a recording to indicate the starting and ending points of the segments of interest according to the users. The embodiment optionally also associates a descriptive data fragment extracted from the social media data streams relative to a segment. This manner of intelligent segment marking in recordings is unavailable in the presently available methods. Thus, a substantial advancement of such devices or data processing systems by executing a method of an embodiment is in enabling a user to be able to skip to, or avoid, a segment based on other users' interest in the segment.

The illustrative embodiments are described with respect to certain content, broadcasts, recording, events, times, durations, thresholds, amounts, frequencies, levels, data fragments, data streams, social media sources, metadata, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

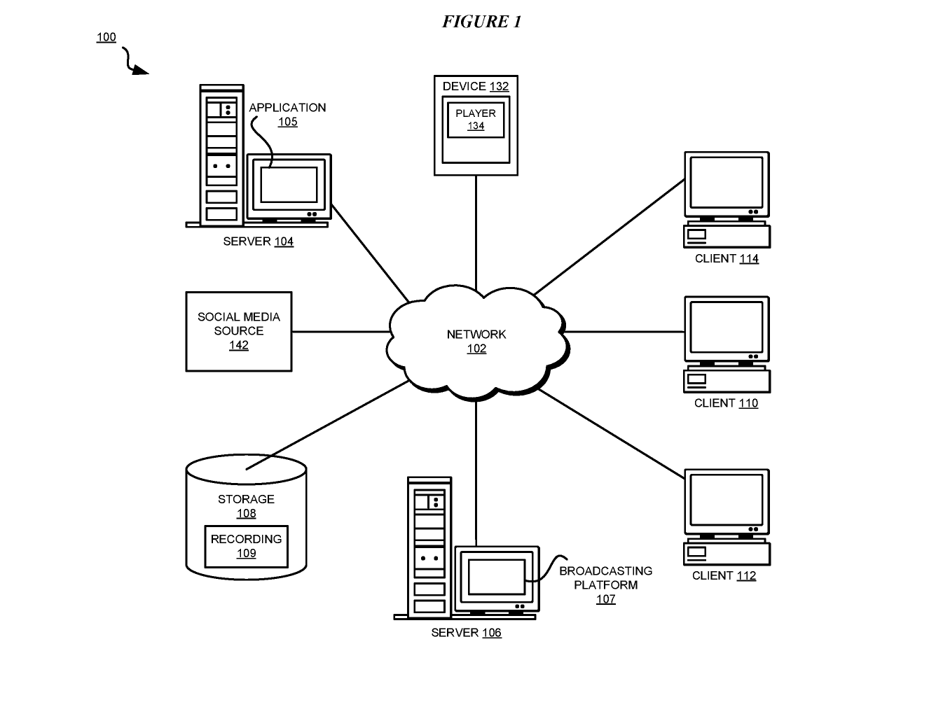

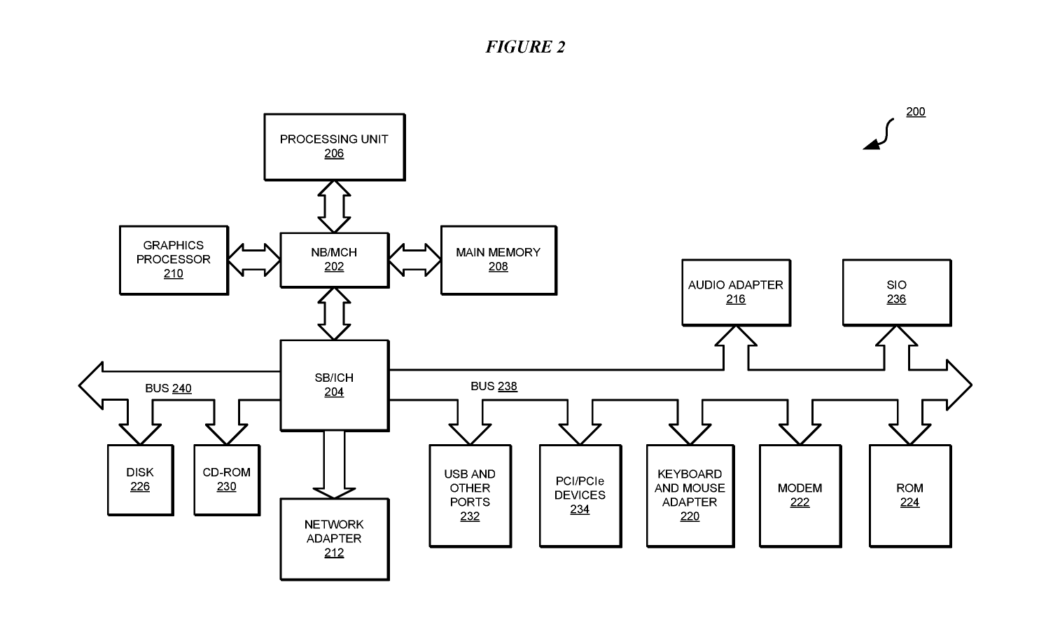

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Application 105 implements an embodiment described herein. Broadcasting platform 107 is any suitable manner of broadcasting content. Application 105 makes recording 109 of the content broadcast by platform 107. Application 105 collects data contributions corresponding to the content of recording 109 from the data streams of one or more social media source 142. Application 105 identifies one or more segments of interest in recording 109 and annotates recording 109 with the starting time and ending time of each such segment. Player 134 is usable to playback recording 109 by skipping to a starting time of a segment of interest, or skipping past a segment of interest, as the case may be.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), Linux® (Linux is a trademark of Linus Torvalds in the United States and other countries), iOS™ (iOS is a trademark of Cisco Systems, Inc. licensed to Apple Inc. in the United States and in other countries), or Android™ (Android is a trademark of Google Inc., in the United States and in other countries). An object oriented programming system, such as the Java™ programming system, may run in conjunction with the operating system and provide calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as application 105 in FIG. 1, are located on storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may Include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

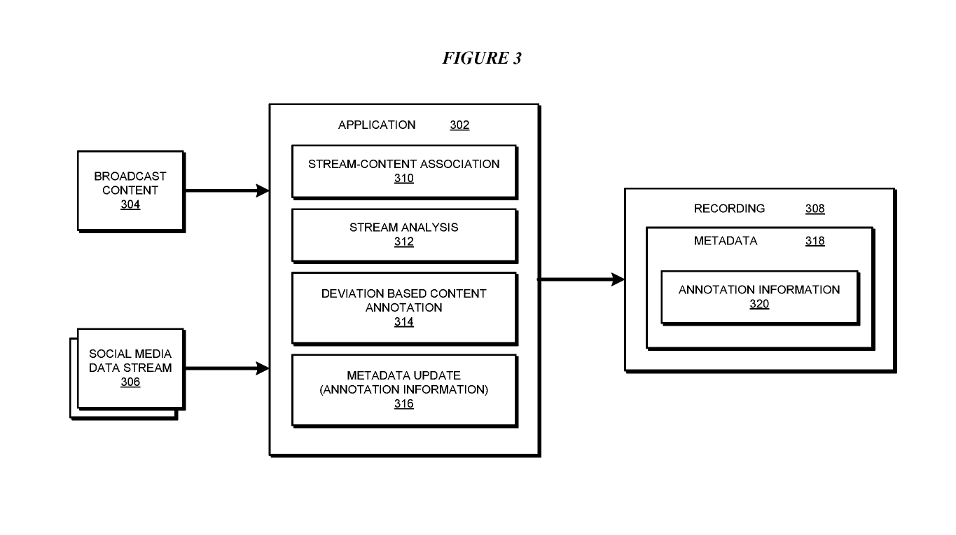

With reference to FIG. 3, this figure depicts a block diagram of an example configuration for intelligent segment marking in recordings in accordance with an illustrative embodiment. Application 302 is an example of application 105 in FIG. 1. A broadcast platform provides content 304 as input to application 302. One or more social media sources, such as social media source 142 in FIG. 1, provide one or more data streams 306 as inputs to application 302. Recording 308 is an example of recording 109 in FIG. 1.

Component 310 analyzes content 304 to determine a set of metadata associated with content 304. Using a subset of the metadata, component 310 selects one or more data streams 306, the selected data streams corresponding to the selected subset of metadata.

Component 312 analyses the data in one or more data streams 306 to establish a baseline level of data contribution during the period of the broadcasting of content 304. Component 312 also analyses data streams 306 to determine a deviation from the baseline level. Component 312 also optionally isolates or extracts one or more data fragments from the data contributions made during the period of the deviation.

Component 314 uses the period of the deviation to identify a segment of interest in content 304. Particularly, component 314 determines a starting time and an ending time of the segment according to the period of the deviation and a predetermined lead time as described herein. Optionally, component 314 can be configured to also adjust the ending time of the segment using a predetermined trailing time.

Component 314 can be further configured to extract one or more data fragments from data streams 306 relative to a segment of interest. Any number of segments of interest in content 304, their starting and ending times, and their related data fragments can be determined in this manner.

Component 316 extends the metadata of content 304 with information about the segment. Particularly, component 316 extends the set of metadata of content 304 by adding, for each segment of interest, a starting time and an ending time within the duration of content 304. Optionally, component 316 can be configured to further extend the set of metadata of content 304 by adding, for each segment of interest, one or more data fragments that are descriptive of the segment according to one or more data streams 306.

Application 302 thus produces recording 308. Metadata 318 is the extended metadata of recording 308 and includes not only the set of metadata originally associated with content 304 but also the extended metadata added by component 316 as described herein. Annotation information 320 is the extended metadata, e.g., the starting time, the ending time, and optionally one or more descriptive data fragments associated with each segment of interest in recording 308 of content 304.

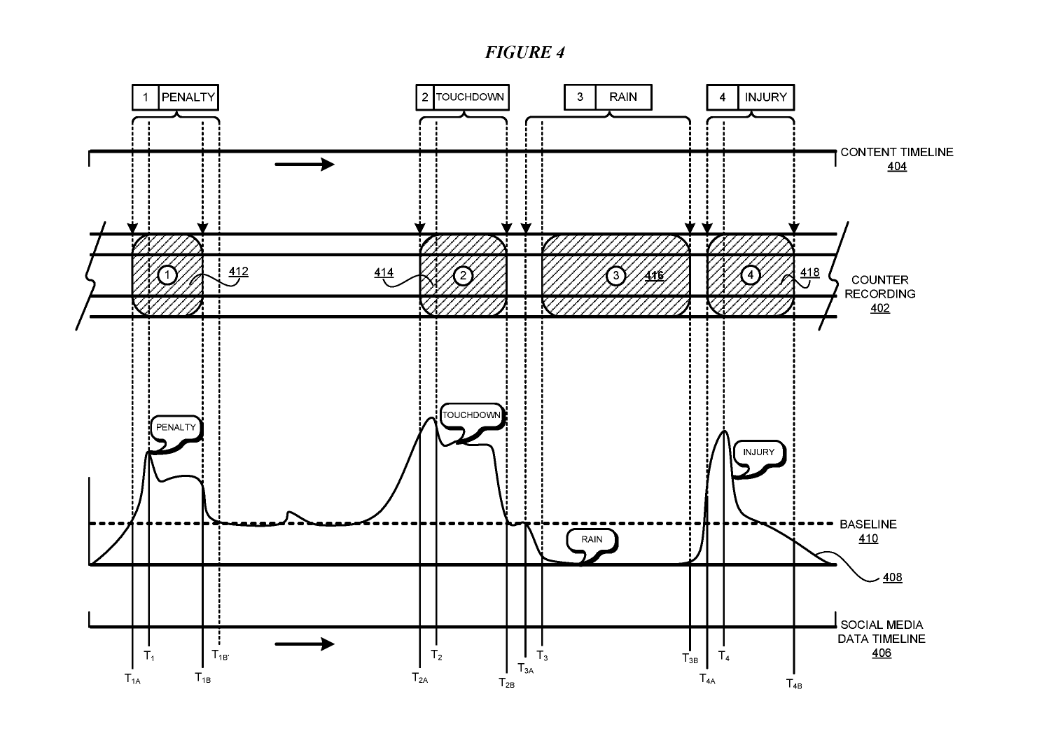

With reference to FIG. 4, this figure depicts a manner of identifying a segment of interest in a given content in accordance with an illustrative embodiment. Recording 403 is an example of recording 308 in FIG. 3. Content timeline 404 depicts the progression of time in recording 402. Social media data timeline 406 shows the progression of time in a social media data stream. Graph 408 shows a level of data contribution in the data stream over timeline 406.

For clarity and simplicity, assume that graph 408 represents the volume of data contributed to the data stream. Baseline 410 is a baseline volume level of data contribution during the original broadcast of the content that formed recording 402. For clarity of the depiction, assume a negligible threshold that has to be exceeded above or below baseline 410 for a segment of interest. Further assume that the content that produced recording 402 pertains to a football game.

An application implementing an embodiment, such as application 302 in FIG. 3, detects at time T1 that a volume of data in the data stream exceeded baseline 410 by more than the threshold (not shown). The application records time T1A, which is a predefined lead amount of time before time T1, as the starting time of a segment of Interest. The application determines that the volume of data in the data stream returned to baseline 410 at time T1B. The application records time T1B, which is the time at which the data volume returned to baseline 410, as the ending time of a segment of interest. For the clarity of the description and not to imply a limitation, assume that the application is configured not to add a trailing time.

Optionally, the application may add a predefined trailing amount of time after time T1B, to record time T1B′ as the ending time of the segment of interest. Furthermore, optionally, the application may extract one or more data fragments from the data between T1A and T1B. A word or a phrase can be a data fragment. As an example, the application may find that the data fragment “penalty” or a phrase containing the data fragment is found in greater than a threshold number of data contributions between times T1A and T1B. The application extracts data fragment “penalty” and associates the data fragment with the segment of interest 1 (412).

For segment of interest 1, the application adds to the metadata of recording 402 time T1A, time T1B, and data fragment “penalty”. Suppose another segment of interest occurs at a touchdown in the game. In a similar manner, the application identifies segment 2 (414) and adds to the metadata of recording 402 time T2A, time T2B, and data fragment “touchdown”.

Segment of interest 3 is a segment where the users lacked interest according to graph 408. The application finds that the lack of interest was due to rainy conditions during the game. In the manner described herein, the application identifies segment 3 (416) and adds to the metadata of recording 402 time T3A, time T3B, and data fragment “rain”.

Other segments of interest may occur for same or different reasons. For example, the application identifies segment 4 (418) and adds to the metadata of recording 402 time T4A, time T4B, and data fragment “injury”.

These examples of data contributions, event scenarios, and segment detection in a single data stream are not intended to be limiting. From this disclosure, those of ordinary skill in the art will be able to conceive many other patterns of data contributions, event scenarios, and segment detection under other circumstances in one or more data streams, and the same are contemplated within the scope of the illustrative embodiments.

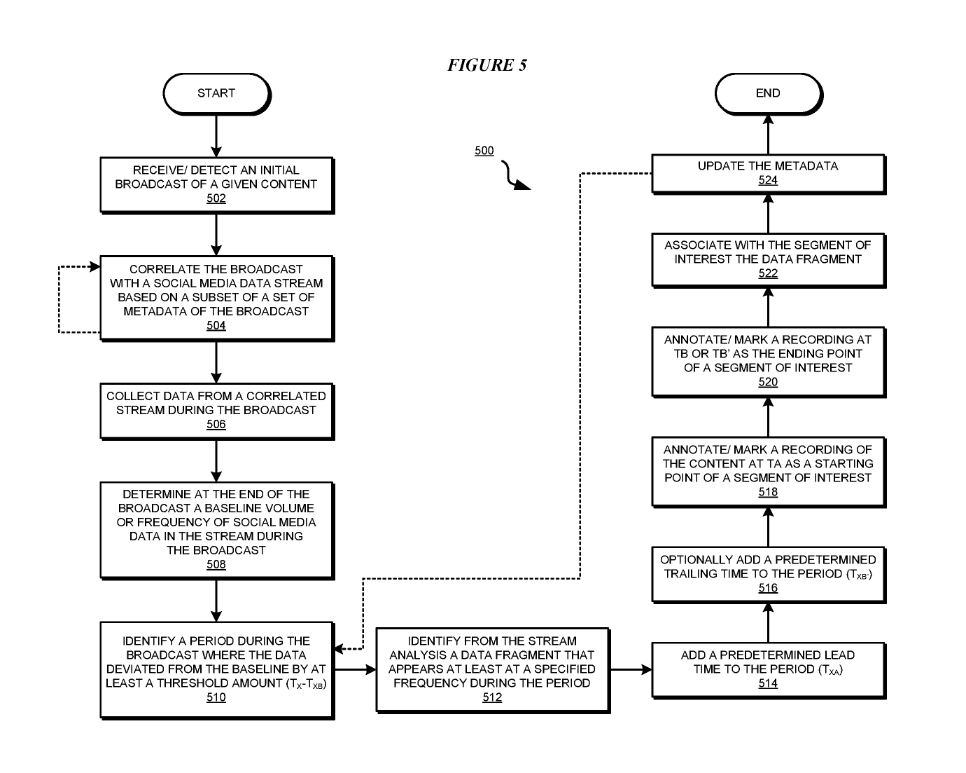

With reference to FIG. 5, this figure depicts a flowchart of an example process for intelligent segment marking in recordings in accordance with an illustrative embodiment. Process 500 can be implemented in application 302 in FIG. 3.

The application receives or detects an initial broadcast of a given content (block 502). The application correlates the broadcast content with a social media data stream based on a subset of a set of metadata of the content (block 504). The application may correlate any number of data streams in this manner.

The application collects data from a correlated stream during the broadcast (block 506). The application determines, at the end of the broadcast, a baseline volume or frequency of data in the stream during the broadcast (block 508).

The application identifies, by analyzing the data collected for the broadcast period, where the data deviated from the baseline by at least a threshold amount (block 510). In other words, the application establishes duration Tx to TxB for segment X as shown in FIG. 4.

The application identifies from the stream analysis a data fragment that appears at least in a threshold number of data contributions during the segment period, with at least a threshold frequency during the segment period, or both (block 512). The application adds a predetermined lead time to the segment period (block 514). In other words, the application rolls back time Tx to time TxA as shown in FIG. 4.

Optionally, the application adds a predetermined trailing time to the segment period (block 516). In other words, the application advances time TxB to time TxB′ as shown in FIG. 4.

The application annotates, marks, or otherwise enables an identification of a beginning of a segment of interest in a recording of the content (block 518). In other words, the application marks the starting time of the segment, e.g., TxA as shown for segment x in FIG. 4.

The application annotates, marks, or otherwise enables an identification of an ending of a segment of interest in a recording of the content (block 520). In other words, the application marks the ending time of the segment, e.g., TxB as shown for segment x in FIG. 4.

If available, the application also associates the data fragment from block 512 with the segment (block 522). The application updates the metadata of the recording with the starting time, the ending time, and the data fragment descriptive of the segment (block 524).

The application repeats blocks 510-524 for as many segments as may be present in the content. The application ends process 500 thereafter.

Thus, a computer implemented method is provided in the illustrative embodiments for intelligent segment marking in recordings. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
collecting, from a social media data source, a stream of data contributions during a period, the period spanning a broadcast of a content;
analyzing, using a processor and a memory, the stream to identify a change in a level of the data contributions during a sub-period of the period;
selecting a first time to mark a beginning of the sub-period;
selecting a second time to mark an ending of the sub-period;
extracting from the data contributions occurring during the sub-period in the stream, a data fragment, the data fragment being descriptive of the content during the sub-period;
selecting, in a recording of the content, a portion of the recording between the starting time and the ending time as a segment of interest; and
annotating the recording with the starting time, the ending time, and the data fragment to identify the segment of interest.

2. The method of claim 1, further comprising:
determining a set of metadata associated with the content;
searching a plurality of data streams from the social media data source related to a subset of the set of metadata; and
selecting the data stream responsive to the data stream relating to the subset of the set of metadata.

3. The method of claim 2, wherein the plurality of data streams includes data streams from a plurality of social media data sources.

4. The method of claim 1, further comprising:
determining that greater than a threshold number of data contributions during the sub-period in the data stream share a phrase; and
selecting the phrase as a data fragment that is descriptive of the segment.

5. The method of claim 1, further comprising:
determining that greater than a threshold frequency of data contributions during the sub-period in the data stream share a phrase; and
selecting the phrase as a data fragment that is descriptive of the segment.

6. The method of claim 5, wherein the phrase is a single word.

7. The method of claim 1, wherein selecting the phrase comprises selecting a plurality of phrases.

8. The method of claim 1, further comprising:
advancing the second time by a predetermined trailing time towards an end of the recording.

9. The method of claim 1, wherein the first time is relative to a time of beginning of the recording.

10. The method of claim 1, further comprising:
rolling back the first time by a predetermined lead time towards a beginning of the recording.

11. The method of claim 1, further comprising:
determining a baseline level of data contributions during the period; and
setting a threshold for deviation from the baseline.

12. The method of claim 11, wherein the change in the level of data contributions exceeds the threshold for deviation above the baseline.

13. The method of claim 12, wherein the change in the level of data contributions exceeds the threshold for deviation below the baseline.
